(19) United States
(12) Patent Application Publication
(10) Pub. No.: US 2013/0341881 A1
(43) Pub. Date: Dec. 26, 2013

(54) SUSPENSION DEVICE FOR VEHICLE, AND METHOD FOR INSTALLING SHOCK ABSORBER

(71) Applicants: Reo Koide, Kawasaki-shi (JP); Masatoshi Mori, Machida-shi (JP); Keiichi Nakajima, Atsugi-shi (JP); Yoshihiro Kawabe, Kamakura-shi (JP)

(72) Inventors: Reo Koide, Kawasaki-shi (JP); Masatoshi Mori, Machida-shi (JP); Keiichi Nakajima, Atsugi-shi (JP); Yoshihiro Kawabe, Kamakura-shi (JP)

(73) Assignee: NISSAN MOTOR CO., LTD

(21) Appl. No.: 14/003,644

(22) PCT Filed: Jan. 17, 2012
(86) PCT No.: PCT/JP2012/050786

§ 371 Date: Sep. 6, 2013

(30) Foreign Application Priority Data
Mar. 9, 2011 (JP) 2011052072

(51) Int. Cl. B60G 3/00

(52) U.S. Cl. CPC B60G 3/00
USPC 280/124.125; 29/428

(57) ABSTRACT

A vehicle suspension apparatus includes: a road-wheel-side member that supports a road wheel rotatably; a lower link member that links the road-wheel-side member to a vehicle body such that the road-wheel-side member swings with respect to the vehicle body in a vehicle vertical direction; a vehicle-body-side member of a vehicle body, wherein the lower link member is attached to the vehicle-body-side member; and a shock absorber, wherein a lower end of the shock absorber is connected to one of the road-wheel-side member and the lower link member, and wherein an upper end of the shock absorber is connected to the vehicle body at a position rearward with respect to the lower end in a vehicle longitudinal direction. This serves to improve load support performance in the vehicle longitudinal direction.

### TECHNICAL FIELD

The present invention relates to a vehicle suspension apparatus and a shock absorber installation method, wherein the vehicle suspension apparatus connects a road wheel to a vehicle body.

### BACKGROUND ART

Conventionally, a vehicle suspension apparatus has been known which is installed at a rear wheel, and connects a shock absorber to a road-wheel-side member, wherein the shock absorber is installed in a substantially upright position in a side view of a vehicle. For example, a patent document 1 discloses a technique for a rear-wheel-side suspension apparatus with which a lower end of a damper unit is connected to a road-wheel-side member, and the damper unit is inserted through an A-arm type upper arm, and is set in a substantially upright position in a side view of a vehicle, and an upper end of the damper unit is connected to a vehicle body. However, in a case where a shock absorber is installed in a substantially upright position in a side view of a vehicle, the shock absorber cannot support a load in a vehicle longitudinal direction, when the load is inputted to a portion of the shock absorber connected to a vehicle body. Accordingly, in such a case, it is difficult to make the shock absorber serve to resist an external force to the vehicle body or a torsional torque applied to the vehicle body in the longitudinal direction. Namely, such a conventional vehicle suspension apparatus installed at a rear wheel is susceptible to improvement in load support performance in a vehicle longitudinal direction.

### PRIOR ART DOCUMENT(S)

### Patent Document(s)

Patent Document 1: JP 2009-29157 A

### SUMMARY OF THE INVENTION

It is an object of the present invention to improve a vehicle suspension apparatus in load support performance in a vehicle longitudinal direction.

In order to achieve the object, according to the present invention, a vehicle suspension apparatus is configured so that a lower end of a shock absorber is connected to one of a road-wheel-side member and the lower link member, and wherein an upper end of the shock absorber is connected to a vehicle body at a position rearward with respect to the lower end in a vehicle longitudinal direction.

According to the present invention, the feature that the shock absorber is in a rearwardly-inclined state makes the shock absorber serve to dampen and support an external force to the vehicle body or a torsional torque occurring in the vehicle body in the vehicle longitudinal direction. This improves the vehicle suspension apparatus in load support performance in the vehicle longitudinal direction.

### BRIEF DESCRIPTION OF THE DRAWINGS

FIG. 1 is a schematic diagram showing entire configuration of an automotive vehicle 1 provided with a suspension apparatus 1S.

FIG. 2 is a diagram showing linkage configuration of suspension apparatus 1S.

FIG. 3 is a top view showing an example of specific configuration of suspension apparatus 1S.

FIG. 4 is a front view showing the example of specific configuration of suspension apparatus 1S.

FIG. 5 is a side view showing the example of specific configuration of suspension apparatus 1S.

FIG. 6 is a perspective view showing the example of specific configuration of suspension apparatus 1S.

FIG. 7 is a diagram illustrating an example of where an upper end of shock absorber 17 is attached (connection point Sb).

FIG. 8 is a diagram (back view) illustrating an example of a structure where the upper end of shock absorber 17 is attached.

FIG. 9 is a diagram illustrating a path of force transmission when an external force is inputted to a vehicle body 1A from the rear side of the vehicle.

FIG. 10 is a diagram showing an example of how a reaction force occurs against an external force, in the case of the present invention, and in a comparative example where shock absorber 17 is installed in a substantially upright position.

FIG. 11 is a diagram schematically showing a torsional torque in the vehicle longitudinal direction which occurs in vehicle body 1A.

FIG. 12 is a diagram showing a relationship between the frequency of the torsional torque and the gain of generated vibration, with respect to variation of the angle of rearward inclination of shock absorber 17.

FIG. 13 is a diagram showing an example of where the lower end of shock absorber 17 is attached.

FIG. 14 is a diagram showing another example of where the lower end of shock absorber 17 is attached.

### MODE(S) FOR CARRYING OUT THE INVENTION

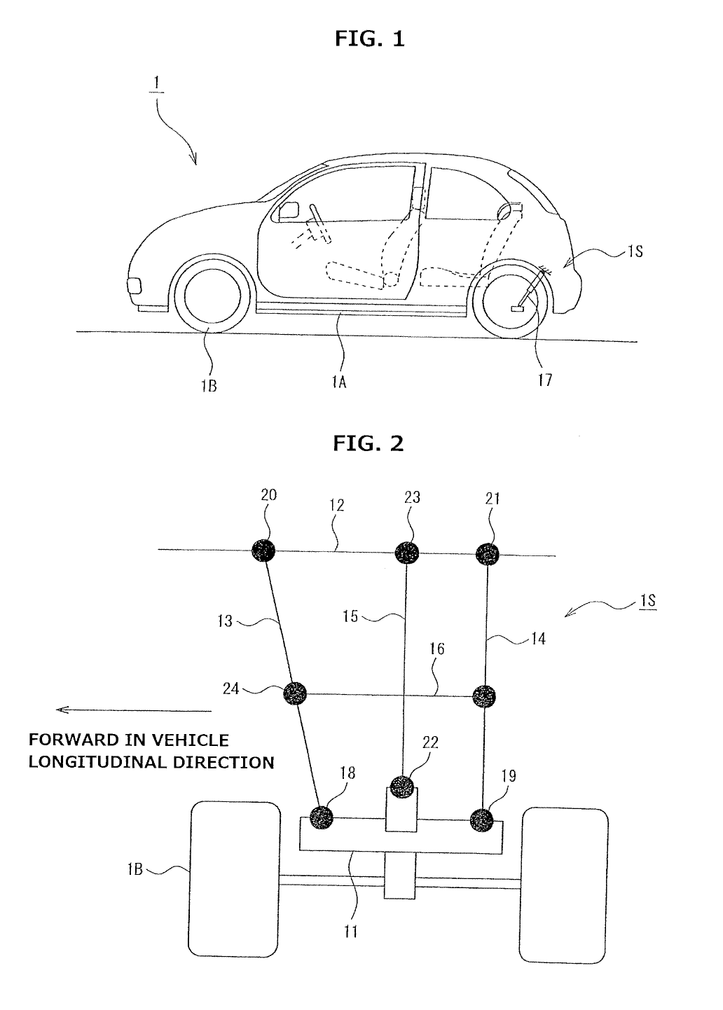

The following describes with reference to the drawings an automotive vehicle according to a first embodiment of the present invention. FIG. 1 is a schematic diagram showing entire configuration of an automotive vehicle 1 provided with a suspension apparatus 1S. FIG. 2 is a diagram showing linkage configuration of suspension apparatus 1S according to the present invention. In FIGS. 1 and 2, automotive vehicle 1 includes a vehicle body 1A, a road wheel 1B, and a rear road wheel suspension apparatus. Suspension apparatus 1S includes an axle (road-wheel-side member) 11, lower link members 13, 14, an upper link member 15, a connecting link member 16, and a shock absorber 17.

Axle 11 supports road wheel 1B rotatably. Two lower link members 13, 14 and upper link member 15 link the axle 11 to a suspension member (vehicle-body-side member) 12 such that axle 11 can swing with respect to suspension member 12 in a vehicle vertical direction. Lower link members 13, 14 are connected to a lower end portion of axle 11 through bushes 18, 19, respectively, such that lower link members 13, 14 can swing with respect to axle 11 in the vehicle vertical direction. Moreover, each lower link member 13, 14 is connected to suspension member 12 through a bush 20, 21 such that lower link member 13, 14 can swing with respect to suspension member 12 in the vehicle longitudinal direction.

Two lower link members 13, 14 are arranged in the vehicle longitudinal direction. Henceforth, when each of two lower link members 13, 14 is to be identified in the description, lower link member 13 on the front side in the vehicle longitudinal direction is referred to as front-side lower link member 13, and lower link member 14 on the rear side in the vehicle longitudinal direction is referred to as rear-side lower link member 14. Upper link member 15 is connected to an upper end portion of axle 11 through a bush 22 such that upper link member 15 can swing with respect to axle 11 in the vehicle vertical direction, and is connected to suspension member 12 through a bush 23 such that upper link member 15 can swing with respect to suspension member 12 in the vehicle vertical direction.

Each bush 18-23 is formed by inserting an elastic member made of rubber into between an inner tube and an outer tube which are nested. In the present embodiment, the outer tube is fixed to an end portion of lower link member 13, 14 or upper link member 15, whereas the inner tube is fixed through a bolt to suspension member 12 or axle 11.

Connecting link member 16 connects two lower link members 13, 14. Connecting link member 16 is fixed to a first one of lower link members 13, 14 (rear-side lower link member 14 in this example), and is connected through a bush 24 to a second one of lower link members 13, 14 (front-side lower link member 13 in this example) such that a specific amount of relative displacement between lower link members 13, 14 is allowed. Specifically, bush 24 has a bush axis directed substantially in the vehicle longitudinal direction, and the outer tube of bush 24 is fixed to the second lower link member, and the inner tube of bush 24 is fixed to connecting link member 16, wherein an elastic member made of rubber is inserted between the inner tube and the outer tube. Accordingly, displacement of connecting link member 16 with respect to the first lower link member is allowed within a range of deformation of bush 24. In this embodiment, connecting link member 16 is fixed to rear-side lower link member 14, and connected to front-side lower link member 13 through the bush 24. In the present embodiment, the rigidity of bush 24 has anisotropy such that the rigidity of bush 24 in the vehicle lateral direction is lower than that in the vehicle vertical direction.

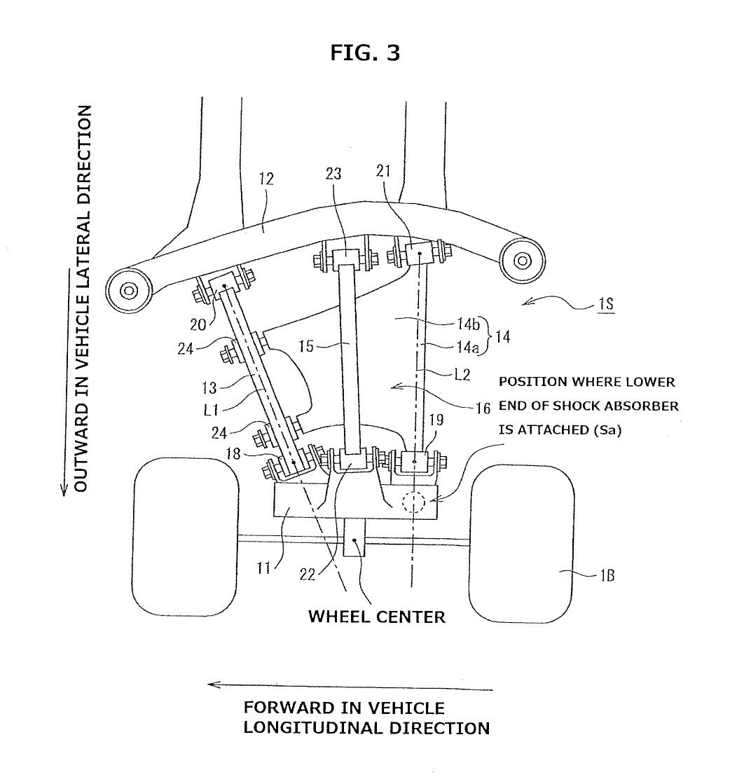

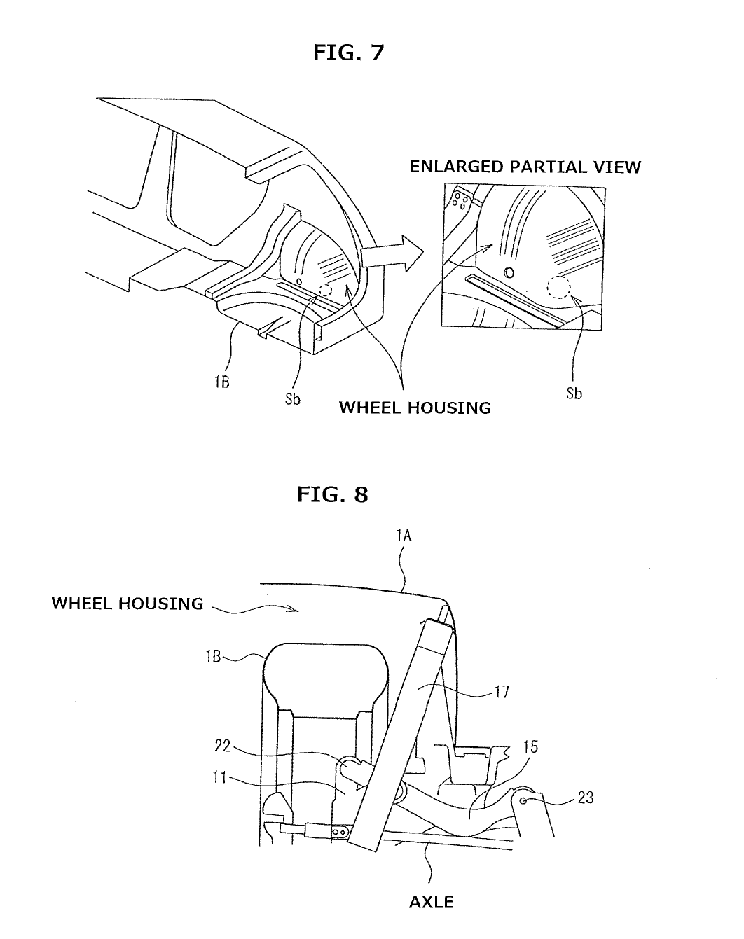

Shock absorber 17 has an upper end connected to vehicle body 1A, and a lower end connected to suspension apparatus 1S, so that shock absorber 17 dampens relative movement between vehicle body 1A and suspension apparatus 1S. Shock absorber 17 is installed in a rearwardly inclined position such that the upper end of shock absorber 17 is located rearward with respect to the lower end in the vehicle longitudinal direction in a side view of the vehicle. Specifically, the lower end of shock absorber 17 is connected to a point (henceforth referred to as connection point Sa) within a region from an axis L1 to an axis L2 (the region containing the axis L2), wherein axis L1 passes through bushes 18, 20 at ends of front-side lower link member 13, and wherein axis L2 passes through bushes 19, 21 at ends of rear-side lower link member 14, as shown in FIG. 3. The upper end of shock absorber 17 is connected to a point (henceforth referred to as connection point Sb) rearward with respect to the upper end of shock absorber 17 in the vehicle longitudinal direction in a rear wheel housing of vehicle body 1A in the side view of the vehicle, as shown in FIG. 7. Since it is sufficient that the position of connection point Sa is located within the region from axis L1 to axis L2, it is possible to enhance the flexibility of layout of shock absorber 17.

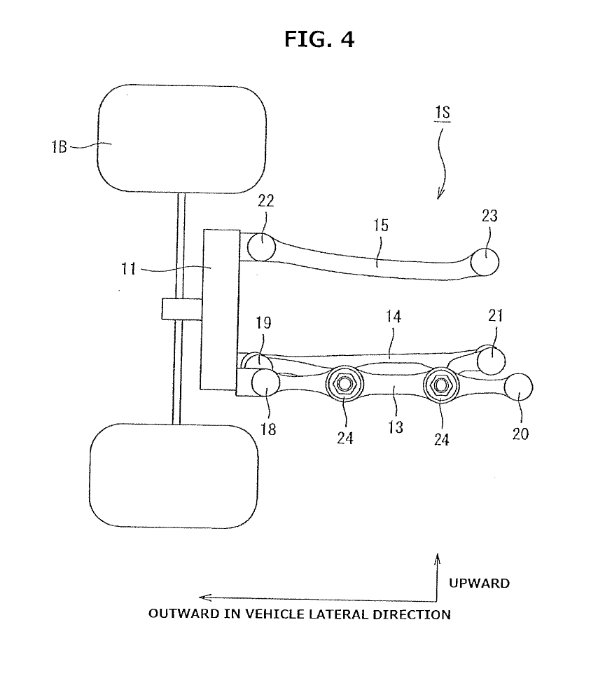

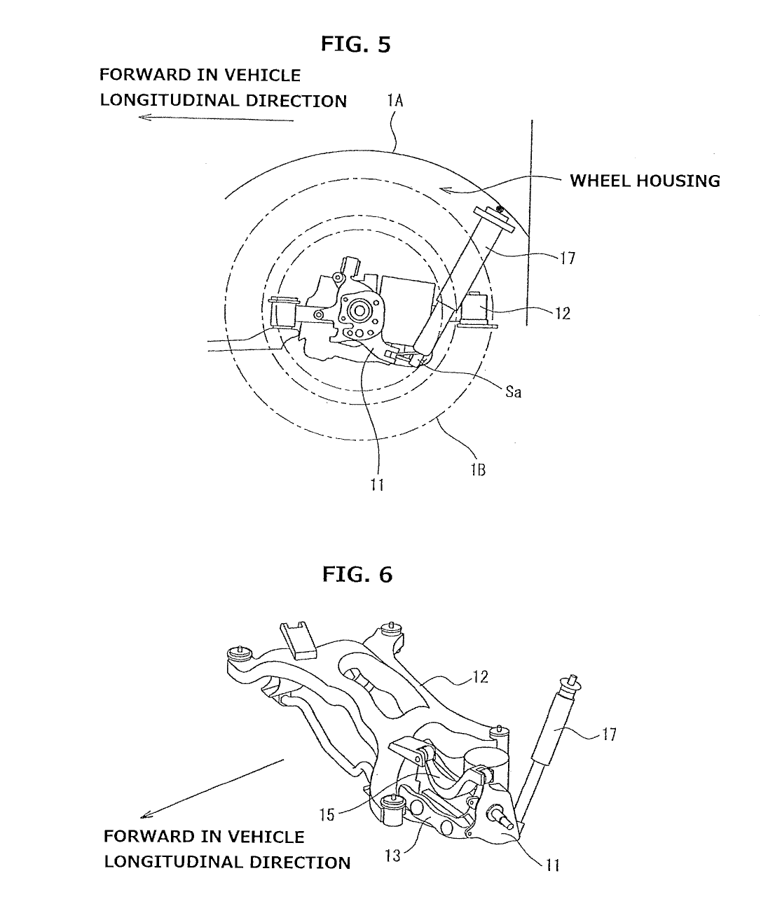

FIGS. 3-6 show an example of specific configuration of suspension apparatus 1S, wherein FIG. 3 is a top view, FIG. 4 is a front view, FIG. 5 is a side view, and FIG. 6 is a perspective view. In FIGS. 3-6, front-side lower link member 13 is a rod extending straight along the axis L1, for example. For example, rear-side lower link member 14 is constituted by a link body part 14a and a projection part 14b, wherein link body part 14a extends along the axis L2, and wherein projection part 14b is formed integrally with link body part 14a, and extends forward from link body part 14a toward front-side lower link member 13 in the vehicle longitudinal direction. Projection part 14b is a plate having a substantially trapezoid shape in a top view of the vehicle. In the example of configuration shown in FIGS. 3-6, projection part 14b constitutes connecting link member 16.

The tip portion of projection part 14b facing the front-side lower link member 13 in the vehicle longitudinal direction is connected to front-side lower link member 13 through two bushes 24 which are arranged with an offset in the vehicle lateral direction. In the present embodiment, each of two bushes 24 which connect front-side lower link member 13 and projection part 14b has a bush axis extending substantially in the vehicle longitudinal direction, and has an outer tube fixed to front-side lower link member 13, and an inner tube fixed to projection part 14b through a mounting bolt. This makes it possible to connect front-side lower link member 13 to rear-side lower link member 14 through bushes 24 as connecting portions such that bushes 24 allow three-dimensional swinging motion, and the amount of swinging motion is limited to a constant according to the span between the outer tube and the inner tube and the rigidity of the elastic member.

In the top view of the vehicle, the span between the connection points of lower link members 13, 14 connected to axle 11 (namely, the connection points of bushes 18, 19) in the vehicle longitudinal direction is shorter than that between the connection points of lower link members 13, 14 connected to suspension member 12 (namely, the connection points of bushes 20, 21). The direction of axis L2 which passes through bush 19 and bush 21 at the ends of rear-side lower link member 14 is substantially identical to the vehicle lateral direction (i.e.

in the direction of the axle). On the other hand, the direction of axis L1. which passes through bush 18 and bush 20 at the ends of front-side lower link member 13 extends from the connection point of bush 20 and is inclined with respect to axis L2.

With the thus-configured axes L1 and L2, when an input is applied to road wheel 1B in the vehicle longitudinal direction due to braking or the like, the road-wheel-side connection points of lower link members 13, 14 are displaced in the vehicle longitudinal direction by substantially equal amounts. With this displacement, a difference occurs in displacement between the road-wheel-side connection points of lower link members 13, 14 in the vehicle lateral direction. The difference in displacement in the lateral direction causes a toe angle change in the toe-in direction, and thereby enhances the stability during braking.

With the thus-configured lower link members 13, 14, the connection point Sa of the lower end of shock absorber 17 may be set in the link body part 14a of rear-side lower link member 14 (namely, on the axis L2), or in the projection part 14b of rear-side lower link member 14 (namely, in the region from axis L2 to axis L1). Moreover, the connection point Sa may be set at a lower end portion of axle 11 (i.e., a lower part below an axle axis) close to bush 19 (namely, on the axis L2), except in the lower link member 14. In the present embodiment, the connection point Sa is set at axle 11 as shown in FIG. 3.

The connection point Sb of the upper end of shock absorber 17 is set at a wheel housing rearward with respect to the connection point Sa in the vehicle longitudinal direction. FIG. 7 is a diagram illustrating an example of where the upper end of shock absorber 17 is attached (connection point Sb). FIG. 8 is a diagram (back view) illustrating an example of a structure where the upper end of shock absorber 17 is attached. As shown in FIGS. 7 and 8, the upper end of shock absorber 17 is connected to a portion of a ceiling portion of the wheel housing which is on the inside of the ceiling portion and on the rear side of the ceiling portion in the vehicle longitudinal direction (for example, at or above a place where a floor of a trunk and the wheel housing are connected).

The following describes operation. In the suspension apparatus 1S according to the present invention, the lower end of shock absorber 17 is connected to a position in the region from axis L1 to axis L2 in lower link member 13, lower link member 14 or the road-wheel-side member, whereas the upper end of shock absorber 17 is connected to a position rearward with respect to the upper end in the side view of the vehicle. This installation method for shock absorber 17 makes the support force of shock absorber 17 serve to resist the load in the vehicle longitudinal direction. Specifically, the support force of shock absorber 17 is used to resist an external force input to vehicle body 1A and a torsional torque in the vehicle longitudinal direction which occurs in the vehicle body 1A. The following describes operation when an external force is inputted to vehicle body 1A and when a torsional torque occurs in vehicle body 1A in the vehicle longitudinal direction.

FIG. 9 is a diagram illustrating a path of force transmission when an external force is inputted to vehicle body 1A from the rear side of the vehicle. As shown in FIG. 9, when an external force is inputted from the rear side of the vehicle, a partial component of the external force is transmitted to the side member of vehicle body 1A as indicated by a broken line in FIG. 9, and supported by the side member. On the other hand, the component of the external force other than the component supported by the side member is inputted to the upper end portion of shock absorber 17 through the vehicle body 1A as indicated by F1 in FIG. 9. The force F1 inputted to shock absorber 17 compresses shock absorber 17 and is thereby dampened, and then inputted from the lower end of shock absorber 17 to lower link member 14 or the vehicle-body-side member (axle 11) as indicated by F2 in FIG. 9.

The force F2 inputted to lower link member 14 or the vehicle-body-side member is inputted to suspension member 12 through bushes 20, 21 as indicated by F3 in FIG. 9. Accordingly, the force inputted from the rear side of the vehicle can be resisted by being supported partially by shock absorber 17 and being transmitted to suspension member 12 in addition to the side member.

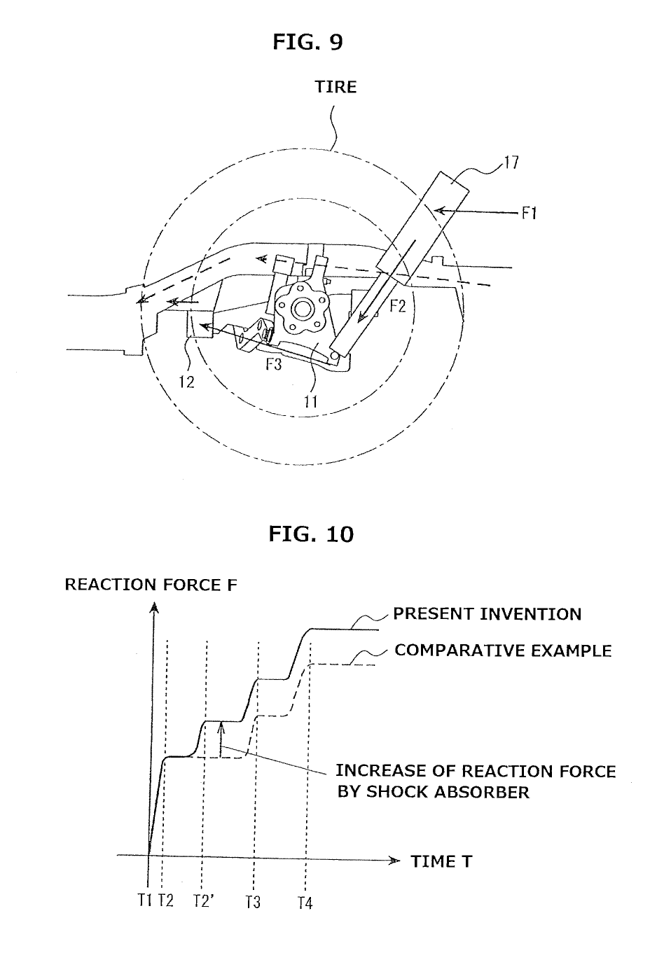

FIG. 10 is a diagram showing an example of how a reaction force occurs against an external force, in the case of the present invention, and in a comparative example where shock absorber 17 is installed in a substantially upright position. As shown in FIG. 10, when a relatively large external force is inputted to vehicle body 1A at a time instant T1, the side member of vehicle body 1A is first compressed to generate a reaction force at a time instant T2 both in the case of the present invention and in the case of the comparative example.

In the case of the comparative example, a reaction force is generated thereafter by compression of the road wheel (tire and wheel) at a time instant T3, and a further reaction force is generated by compression of suspension member 12 at a time instant T4. In contrast, in the case of the present invention, after time instant T2, a part of the external force is inputted to shock absorber 17, so that shock absorber 17 causes a reaction force at a time instant T2′. Thereafter, a reaction force is generated by compression of the road wheel (tire and wheel) at time instant T3, and a further reaction force is generated by compression of suspension member 12 at time instant T4. Accordingly, it is possible to generate a larger force totally by a reaction force generated by shock absorber 17, when an external force is inputted from the rear side of the vehicle, and thereby enhance load support performance in the vehicle longitudinal direction.

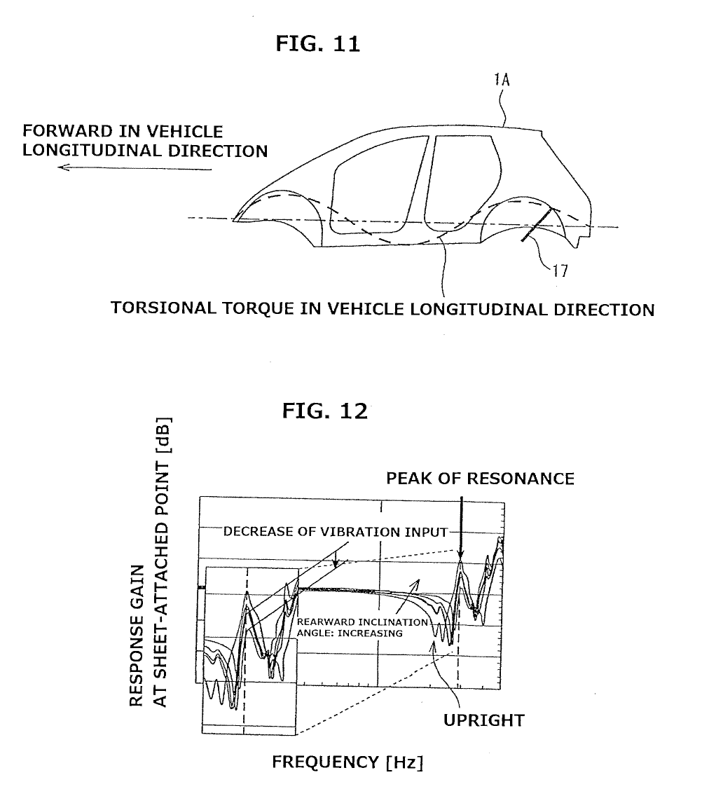

FIG. 11 is a diagram schematically showing a torsional torque in the vehicle longitudinal direction which occurs in vehicle body 1A. As shown in FIG. 11, when a torsional torque occurs in the vehicle longitudinal direction, the rearward inclination of shock absorber 17 in the side view of the vehicle according to the present invention serves to make shock absorber 17 dampen the torsional torque. FIG. 12 is a diagram showing a relationship between the frequency of the torsional torque and the gain of generated vibration, with respect to variation of the angle of rearward inclination of shock absorber 17. As shown in FIG. 12, the torsional torque results in a vibration of vehicle body 1A, which vibration becomes maximized under condition that the shock absorber 17 is in an upright position as indicated by a broken line in FIG. 12, and the vibration decreases as the rearward inclination angle of shock absorber 17 increases.

Namely, the rearward inclination of shock absorber 17 from the upright position results in that the shock absorber 17 supports the torsional torque in the vehicle longitudinal direction. Accordingly, when a torsional torque occurs in the vehicle longitudinal direction, it is possible to suppress the torsional torque by the dampening of shock absorber 17, and thereby enhance the load support performance in the vehicle longitudinal direction.

As described above, the suspension apparatus 1S according to the present invention is configured so that the upper end of shock absorber 17 is connected to vehicle body 1A at a position rearward in the vehicle longitudinal direction with respect to the connection point between the lower end and the road-wheel-side member, and shock absorber 17 is thereby rearwardly inclined. This serves to dampen and support an external force inputted from the rear of the vehicle and a torsional torque in the vehicle longitudinal direction which occurs in vehicle body 1A.

Accordingly, it is possible to enhance the vehicle suspension apparatus in the load support performance in the vehicle longitudinal direction. Suspension apparatus 1S is provided with connecting link member 16 which connects lower link members 13, 14, wherein the lower end of shock absorber 17 is set at a position within the region from the axis L2 of rear-side lower link member 14 to the axis L1 of front-side lower link member 13. Moreover, connecting link member 16 is constituted by projection part 14b that is a plate formed integrally with rear-side lower link member 14. This serves to broaden the allowable area of the position to which the lower end of shock absorber 17 is connected, and thereby enhance the flexibility of layout of shock absorber 17.

The suspension apparatus 1S of the present embodiment may be applied to various kinds of vehicles. It is more effective, especially when it is applied to a vehicle in which a rear wheel housing is close to a rear end of the vehicle (for example, wagon-type vehicles and one-box type vehicles). This is because in the case of a vehicle in which a rear wheel housing is close to a rear end of the vehicle, the upper end of shock absorber 17 is connected at a position close to the rear end of the vehicle where the external force is inputted, and shock absorber 17 thereby exerts high load support performance in the vehicle longitudinal direction.

Although the vehicle suspension apparatus of the type that includes upper link member 15 and lower link members 13, 14 is described as an example in the first embodiment, the present invention may be applied to a vehicle suspension apparatus which is provided no upper link member, for example, is of a strut-type. In the present embodiment, axle 11 corresponds to the road-wheel-side member, and lower link members 13, 14 correspond to the lower link member. Suspension member 12 corresponds to the vehicle-body-side member, shock absorber 17 corresponds to the shock absorber. Front-side lower link member 13 corresponds to the front-side lower link member, rear-side lower link member 14 corresponds to the rear-side lower link member. Connecting link member 16 corresponds to the connecting link member.

The first embodiment produces the following advantageous effects. (1) The first embodiment is configured so that a lower end of a shock absorber is connected to one of a road-wheel-side member and the lower link member, and wherein an upper end of the shock absorber is connected to a vehicle body at a position rearward with respect to the lower end in a vehicle longitudinal direction. Accordingly, the feature that the shock absorber is in a rearwardly-inclined state makes the shock absorber serve to dampen and support an external force to the vehicle body or a torsional torque occurring in the vehicle body in the vehicle longitudinal direction. This improves the vehicle suspension apparatus in load support performance in the vehicle longitudinal direction.

(2) The lower end of the shock absorber is connected to the lower link member at a position within a region from a first axis to a second axis, wherein the first axis passes through a connection point of the rear-side lower link member connected to the vehicle-body-side member and a connection point of the rear-side lower link member connected to the road-wheel-side member, and wherein the second axis passes through a connection point of the front-side lower link member connected to the vehicle-body-side member and a connection point of the front-side lower link member connected to the road-wheel-side member. This serves to broaden the allowable area of the position to which the lower end of the shock absorber is connected, and thereby enhance the flexibility of layout of the shock absorber.

(3) The first embodiment includes a connecting link member that connects the front-side lower link member to the rear-side lower link member, and the lower end of the shock absorber is connected to one of the road-wheel-side member, the rear-side lower link member, and the connecting link member. The number of members that can be connected to the lower end of the shock absorber becomes large, thus enhancing the flexibility of layout. (4)

The connecting link member is a plate formed integrally with the rear-side lower link member, and the connecting link member extends from the rear-side lower link member toward the front-side lower link member. This serves to broaden the allowable area of the position to which the lower end of the shock absorber is connected, and thereby enhance the flexibility of layout of the shock absorber.

(5) A lower end of a shock absorber is connected to one of a road-wheel-side member and a lower link member, wherein the road-wheel-side member supports a road wheel rotatably, and wherein the lower link member links the road-wheel-side member to a vehicle body such that the road-wheel-side member swings with respect to the vehicle body in a vehicle vertical direction; and an upper end of the shock absorber is connected to the vehicle body at a position rearward with respect to the lower end in a vehicle longitudinal direction. Accordingly, it is possible to make the rearwardly-inclined shock absorber serve to dampen and support an external force to the vehicle body or a torsional torque occurring in the vehicle body in the vehicle longitudinal direction. This improves the vehicle suspension apparatus in load support performance in the vehicle longitudinal direction.

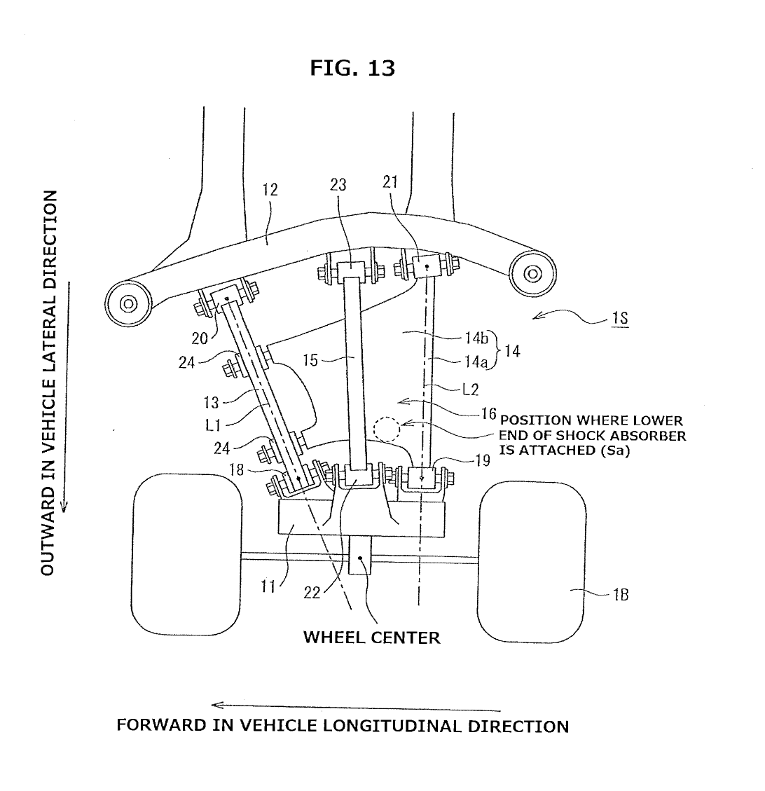

The first embodiment is described for the case that the lower end of shock absorber 17 is connected to a portion within the region defined by the axes L1 and L2 of lower link members 13, 14. If the lower end of shock absorber 17 is connected to a position in the region as detailed below, it produces a special effect. FIG. 13 is a diagram showing an example of where the lower end of shock absorber 17 is attached. As shown in FIG. 13, the lower end of shock absorber 17 can be connected to a portion of projection part 14b of rear-side lower link member 14 below the axle axis (closer to the axle axis than link body part 14a in the top view of the vehicle). In this case, it is possible to reduce the offset from the axle axis to the lower end (connection point Sa) of shock absorber 17, and thereby suppress motion of rear-side lower link member 14 in the windup direction which results from the support force of shock absorber 17.

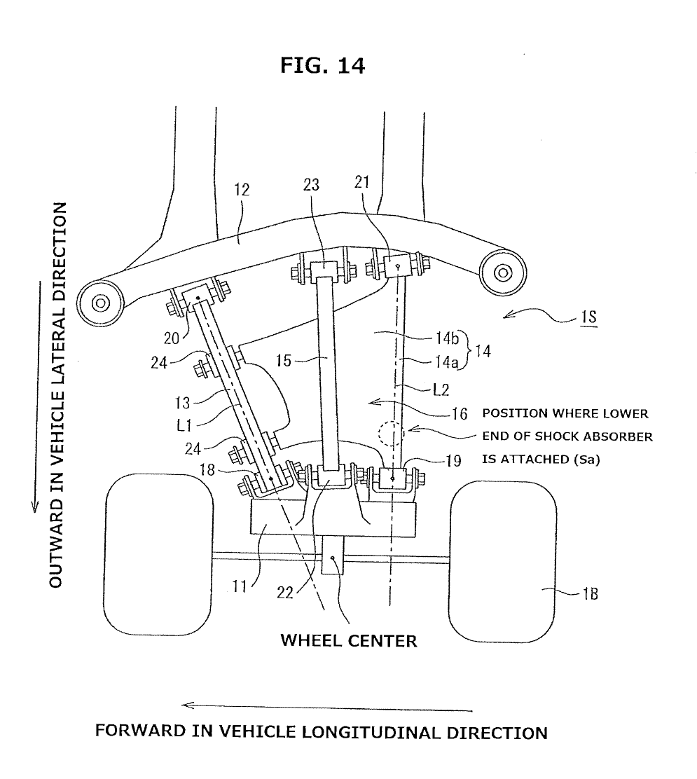

Moreover, if the lower end of shock absorber 17 is connected at a position detailed below, it produces another effect. FIG. 14 is a diagram showing another example of where the lower end of shock absorber 17 is attached. As shown in FIG. 14, the lower end to shock absorber 17 may be connected to the link body part 14a of rear-side lower link member 14. In this case, the lower end (connection point Sa) of shock absorber 17 can be supported by the link body part 14a whose rigidity is relatively high.

1. A vehicle suspension apparatus comprising:
a road-wheel-side member that supports a road wheel rotatably;
a lower link member that links the road-wheel-side member to a vehicle body such that the road-wheel-side member swings with respect to the vehicle body in a vehicle vertical direction;
a vehicle-body-side member of a vehicle body, wherein the lower link member is attached to the vehicle-body-side member; and
a shock absorber, wherein a lower end of the shock absorber is connected to one of the road-wheel-side member and the lower link member, and wherein an upper end of the shock absorber is connected to the vehicle body at a position rearward with respect to the lower end in a vehicle longitudinal direction.

2. The vehicle suspension apparatus as claimed in claim 1, wherein:
the lower link member includes a front-side lower link member and a rear-side lower link member, wherein the front-side lower link member and the rear-side lower link member are arranged in the vehicle longitudinal direction; and
the lower end of the shock absorber is connected to the lower link member at a position within a region from a first axis to a second axis, wherein the first axis passes through a connection point of the rear-side lower link member connected to the vehicle-body-side member and a connection point of the rear-side lower link member connected to the road-wheel-side member, and wherein the second axis passes through a connection point of the front-side lower link member connected to the vehicle-body-side member and a connection point of the front-side lower link member connected to the road-wheel-side member.

3. The vehicle suspension apparatus as claimed in claim 2, wherein:
the lower link member includes a connecting link member that connects the front-side lower link member to the rear-side lower link member; and
the lower end of the shock absorber is connected to one of the road-wheel-side member, the rear-side lower link member, and the connecting link member.

4. The vehicle suspension apparatus as claimed in claim 3, wherein:
the connecting link member is a plate formed integrally with the rear-side lower link member;
the connecting link member extends from the rear-side lower link member toward the front-side lower link member; and
the connecting link member is connected to the front-side lower link member through a bush.

5. The vehicle suspension apparatus as claimed in claim 4, wherein the lower end of the shock absorber is connected to a portion of the connecting link member below an axle axis.

6. A shock absorber installation method comprising:
installing a shock absorber in a rearwardly-inclined position by:
connecting a lower end of the shock absorber to one of a road-wheel-side member and a lower link member, wherein the road-wheel-side member supports a road wheel rotatably, and wherein the lower link member links the road-wheel-side member to a vehicle body such that the road-wheel-side member swings with respect to the vehicle body in a vehicle vertical direction; and
connecting an upper end of the shock absorber to the vehicle body at a position rearward with respect to the lower end in a vehicle longitudinal direction.
